(19) United States
(12) Patent Application Publication
(10) Pub. No.: US 2009/0243581 A1
(43) Pub. Date: Oct. 1, 2009

(54) ELECTRICAL OUTLET DEVICE

(75) Inventor: John F. Taylor, Ortonville, MI (US)

Correspondence Address: GIFFORD, KRASS, SPRINKLE,ANDERSON & CITKOWSKI, P.C, PO BOX 7021, TROY, MI, 48007-7021, US

(73) Assignee: Safety Technology International, Inc., Waterford, MI (US)

(21) Appl. No.: 12/398,239

(22) Filed: Mar. 5, 2009

Related U.S. Application Data
(60) Provisional application No. 61/033,938, filed on Mar. 5, 2008.

(51) Int. Cl. G05F 3/04

(52) U.S. Cl. 323/305

(57) ABSTRACT

An electrical outlet device is provided, the device operable to produce a step-down voltage to an electrically powered system. The electrical outlet device can include a housing, a power inlet electrical plug that extends from the housing and at least one power outlet electrical socket that is connected in parallel to the power inlet electrical plug. A load is also included within the housing and connected in parallel to the at least one power outlet socket, the load providing a step-down voltage. Also included can be a pair of power outlet electrical contacts that extend from the load, the pair of electrical contacts being connected to the load and providing the step-down voltage to the electrically powered system.

### CROSS-REFERENCE TO RELATED APPLICATIONS

This application claims priority of U.S. Provisional Patent Application Ser. No. 61/033,938 filed on Mar. 5, 2008, which is incorporated herein by reference.

### FIELD OF THE INVENTION

The present invention is directed to an electrical outlet device, and more particularly to an electrical output device that provides a step-down voltage.

### BACKGROUND OF THE INVENTION

The use of step-down transformers that plug into a standard wall socket is known to those in the art. Such types of electrical output devices are used to provide a step-down voltage to appliances such as battery chargers, laptop computers and the like. Step-down transformers can also be used to provide a step-down or reduced voltage to a control system of a security alarm system.

Heretofore step-down transformers that plug into a standard electrical wall socket have resulted in the wall socket being unavailable for typical use to provide power to appliances such as lamps, radios, televisions and the like. For example, step-down transformers that are used to provide reduced voltage power to security alarm systems are typically mounted to the wall socket and prevent the use of the wall socket to power any additional appliances. As such, an improved electrical outlet device that can provide a step-down voltage to a desirable electrical system and yet still provide a standard voltage power to appliances that typically use the standard wall socket would be desirable.

### SUMMARY OF THE INVENTION

An electrical outlet device is provided, the device being operable to produce a step-down voltage to an electrically powered system. The electrical outlet device can include a housing, a power inlet electrical plug that extends from the housing and at least one power outlet electrical socket that is connected in parallel to the power inlet electrical plug. A load is also included within the housing and connected in parallel to the at least one power outlet socket, the load providing a step-down voltage. Also included can be a pair of power outlet electrical contacts that extend from the load, the pair of electrical contacts being connected to the load and providing the step-down voltage to the electrically powered system.

In some instances, the power inlet electrical plug is a three-pronged 120 volt alternating current electrical plug. In addition, the at least one power outlet electrical outlet can be a three-pronged 120 volt alternating current electrical socket. The load can be a step-down transformer having a core, a primary coil and a secondary coil, the primary coil being connected in parallel to the power inlet electrical plug and the secondary coil connected in parallel to the pair of electrical outlet contacts.

### BRIEF DESCRIPTION OF THE DRAWINGS

FIG. 1 is a perspective view of an embodiment of the present invention;

FIG. 2 is a perspective view of a back side of the embodiment shown in FIG. 1;

FIG. 3 is a schematic circuit diagram of an embodiment of the present invention;

FIG. 4 is a schematic circuit diagram of another embodiment of the present invention; and

FIG. 5 is a schematic circuit diagram of the load shown in FIGS. 3 and 4.

### DETAILED DESCRIPTION OF THE PREFERRED EMBODIMENTS

The present invention is directed generally to an electrical outlet device that can provide a step-down voltage to an electrically powered system. As such, the electrical outlet device has utility as an electrical component.

The electrical output device disclosed herein can include a housing with a power inlet electrical plug extending from the housing. In addition, at least one power outlet electrical socket, that is at least partially within the housing, is connected in parallel to the electrical plug. It is appreciated that the parallel connection of the at least one power outlet electrical socket to the power inlet electrical plug provides an equivalent voltage power to be obtained from the outlet electrical sockets as is provided to the power inlet electrical plug. In addition to the power outlet electrical sockets, a load is provided within the housing and connected in parallel to the at least one power outlet electrical socket. The load provides a step-down voltage that can be provided to an electrically powered system by using a pair of outlet electrical contacts that are connected in parallel to the load.

In some instances, the power inlet electrical plug is a three-pronged 120 volt alternating current (VAC) electrical plug that is operable to be inserted within a standard 120 VAC wall socket. For example, the plug and the socket can be a National Electrical Manufacturers Association (NEMA) 5-15 plug and receptacle, respectively. In the alternative, a 240 VAC plug and socket can be used.

The load can be a step-down transformer having a core, a primary coil and a secondary coil. The primary coil is connected in parallel to the power inlet electrical plug and the secondary coil is connected in parallel to the pair of power outlet electrical contacts. When the power inlet electrical plug is a three-pronged 120 VAC electrical plug, the step-down transformer can have an input of generally 120 VAC at 60 cycles per second (Hz) and an output of generally 16 VAC at 60 Hz. It is appreciated that the 16 VAC can be used to energize an electrically powered system, illustratively including a security alarm system. It is further appreciated that the input voltage and the step-down voltage can be generally different voltage values and still be within the scope of the present invention. For example, the electrical outlet device could use an input voltage of 240 VAC at 50 Hz or 240 VAC 60 Hz and supply a step-down voltage of 16 VAC at 60 Hz or some other step-down voltage value.

The electrical outlet device can also include a surge protector to protect the at least one power outlet electrical socket and/or a surge protector to protect the step-down transformer. In addition, a surge protector in the form of a thermistor can be connected in series between the secondary coil of the step-down transformer and the pair of power outlet electrical contacts in order to ensure that an electrical short of the pair of power outlet electrical contacts prevents damage to the device and/or a security alarm system connected thereto.

Other components can be connected in parallel to the power inlet electrical plug and/or the pair of power outlet electrical contacts. For example, an LED light can be connected in parallel to the power inlet electrical plug such that an individual is alerted as to when power is being supplied to the electrical outlet device and/or when the pair of power outlet electrical contacts has been shorted. Likewise, components such as voltage suppressors, capacitors, resistors and the like can also be included within the housing.

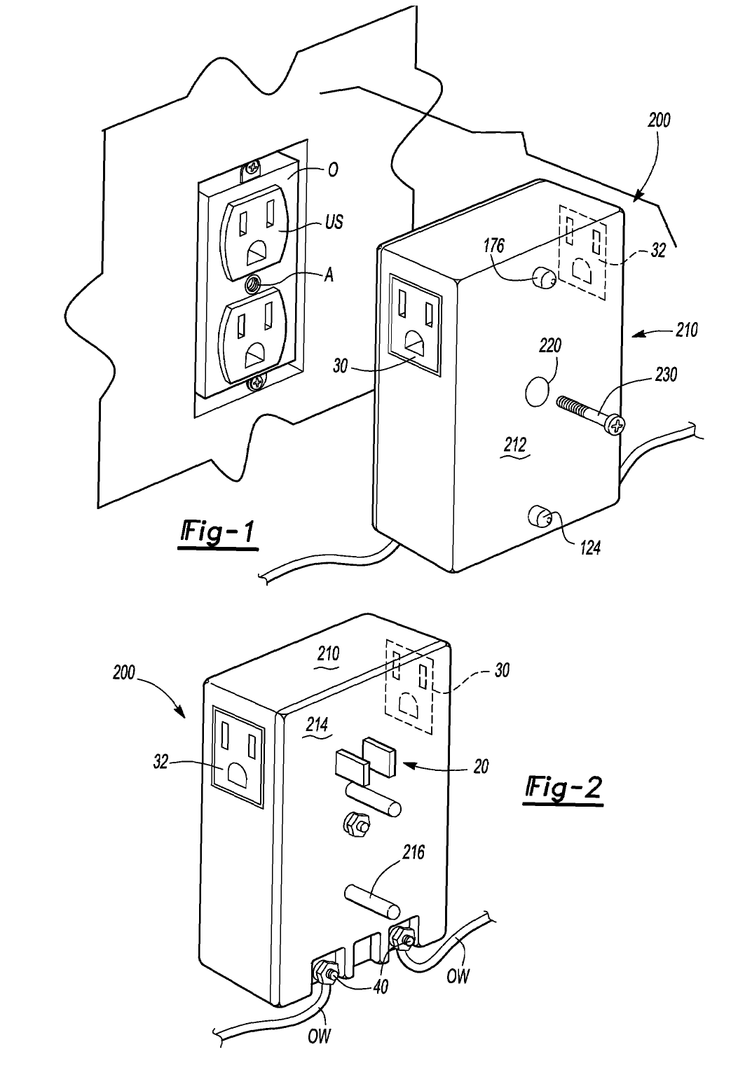

Turning now to FIGS. 1 and 2, an embodiment of the electrical outlet device is shown generally at reference numeral 200. FIG. 1 shows a front perspective view of the device 200 along with a wall outlet O to which the device 200 can be plugged into. The device 200 has a housing 210 with a front wall 212 and a rear wall 214. Extending from the rear wall 214 is a power inlet electrical plug 20 and a positioning plug 216. It is appreciated that the power inlet electrical plug 20 can be inserted into the upper socket US of the outlet O in order to obtain electrical power. It is further appreciated that the positioning plug 216 can be made of plastic or some other insulating material and/or can be part of the rear wall 214. In some instances, the wall outlet O provides generally 120 VAC at 60 Hz. Stated differently, the wall outlet O can be a standard outlet or receptacle used in North America that provides 120 VAC±15%. The scope of the electrical outlet device 200 also includes wall outlets that are used in other regions of the world and thus is not necessarily confined to 120 VAC.

At least partially within the housing 210 is at least one power outlet electrical socket 30, and in some instances includes a second power outlet electrical socket 32. The power outlet electrical sockets 30 and 32 are connected in parallel to the power inlet electrical plug 20 and thereby afford for 120 VAC to an appliance that is plugged therein. In some instances, an LED 176 can also be connected in parallel to the power inlet electrical plug 20 and thereby provide an indicator as to whether or not power is being supplied from the wall outlet O to the device 200 after the power inlet electrical plug 20 has been plugged into the wall outlet O. Also shown in FIG. 1 is an aperture 220 within the housing 210 and a fastening device 230, the fastening device 230 dimensioned to fit within the aperture 220 and attach the housing 210 to the wall outlet O using the aperture A within the outlet. As shown in this figure, the attachment device 230 can be a threaded screw or bolt that can thread into a threaded aperture A. It is appreciated that once the device 200 is plugged into the wall outlet O and the housing 210 is attached thereto, that the power outlet electrical sockets 30 and 32 afford for continued use or supply of 120 VAC to appliances such as lamps, radios, clocks and the like. It is further appreciated that the exact location of the power outlet socket 30 and/or socket 32 is not critical and that the socket 30 and/or 32 can be located on the front wall 212 and/or can rotate or swivel between a side facing position and forward facing position.

Looking specifically at FIG. 2, the rear wall 214 has at least two power outlet electrical contacts 40 extending therefrom. The electrical contacts 40 are connected in parallel to a load (not shown) that is within the housing 210, the load providing a step-down voltage to the contacts 40. It is appreciated that an output wire OW can be attached to the contacts 40 and be used to provide power to an electrically powered system, illustratively including a security alarm system and/or to a circuit board of a security alarm system.

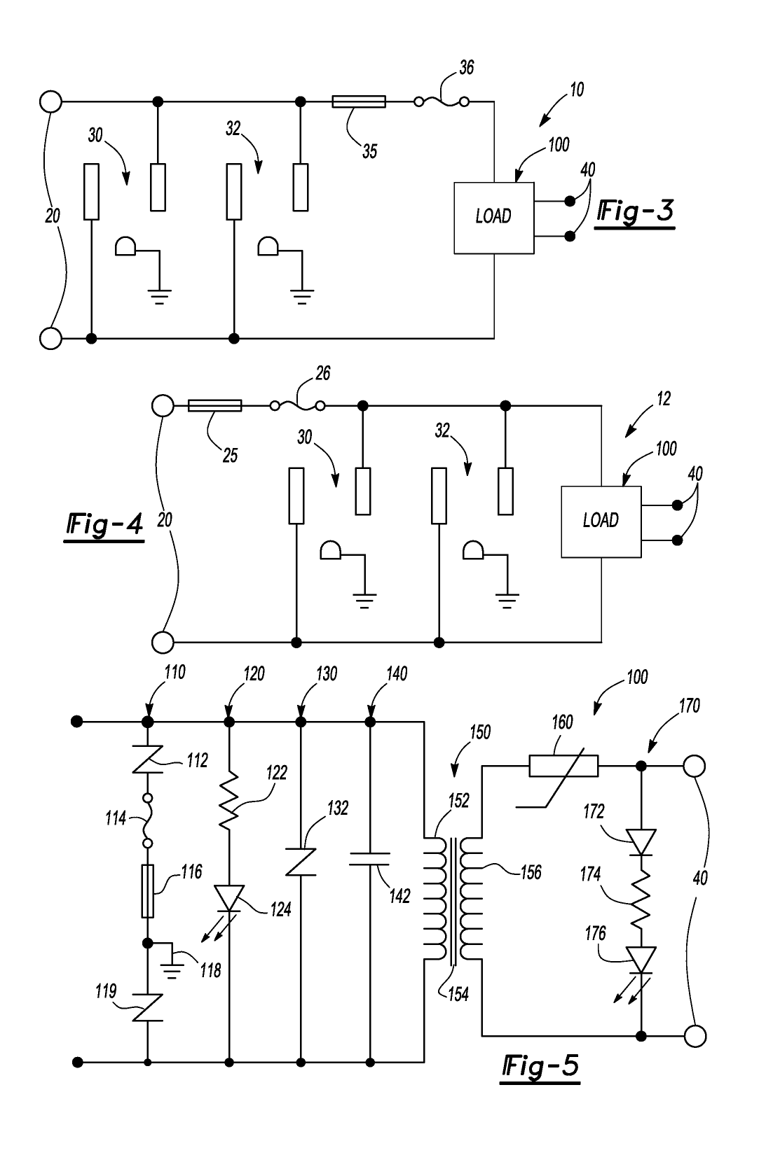

Turning now to FIG. 3, a schematic circuit diagram of an embodiment of the electrical outlet device 200 is shown. The power inlet electrical plug 20 can accept power from a wall outlet and the power outlet electrical sockets 30 and 32 are connected in parallel thereto. In this manner, the power that is provided to the plug 20 can be accessed or provided by the sockets 30 and 32. Also connected in parallel to the plug 20, the socket 30 and the socket 32 is a load 100. The load 100 can provide a step-down voltage to the electrical contacts 40. In some instances, a surge protector in the form of a fuse 35 and/or a thermal fuse 36 can be connected in series between the socket 32 and the load 100. In other instances, a surge protector in the form of a fuse 25 and/or a thermal fuse 26 can be connected in series between the plug 20 and the socket 30 in order to provide protection to the outlet sockets and/or the load 100 as shown in FIG. 5. It is appreciated that any type of surge protection switch can be used and is not limited to the fuse and/or thermal fuse shown in the figures.

Looking now at FIG. 5, an embodiment of the load 100 is shown wherein optional parallel-connected components are illustrated at reference numerals 110, 120, 130, 140, 150 and 170. For example, the parallel connection shown at 110 can include optional voltage suppressor 112 and/or 119, the thermal fuse 114, a fuse 116 and/or a ground 118. Also included can be a resistor 122 and a light emitting diode 124 that can be used to provide an indication that power has been supplied to the device 200 from the wall outlet O. Optional components such as an additional voltage suppressor 132 and/or a capacitor 142 can also be included to further regulate the amperage and/or power supplied to the step-down transformer 150.

The step-down transformer 150 is shown with a primary coil 152, a coil 154 and a secondary coil 156. Connected in parallel to the secondary coil 156 can be the power outlet electrical contacts 40, a diode 172, a resistor 174 and/or an LED 176. The LED 176 can provide an indication as to whether or not the contacts 40 have been electrically shorted. In addition, an internal resettable polymer fuse 160 can be connected in series between the secondary coil 156 and the electrical contacts 40. It is appreciated that if the contacts 40 are shorted, the polymer fuse 16 is heated and creates an open circuit, thereby resulting in the energizing of the LED 176.

As discussed above, the plug 20 can receive 120 VAC power from the wall outlet O, supply the 120 VAC power to a plurality of power outlet electrical sockets that are at least partially within the housing 210 and provide the 120 VAC power to the primary coil 152 of the step-down transformer 150. Thereafter, the transformer 150 provides a step-down voltage from the secondary coil 156 to the electrical contacts 40. In some instances, the step-down voltage can be 16 VAC±15% at 60 Hz and generally 2.4 amps. It is appreciated that the construction and manufacture of the device 200 can be such that the device is approved by the Underwriters Laboratories (UL). In addition, the surge protectors can be common mode surge protectors with thermal fusing and that the outlets 30 and 32 can be rated at 15 amps and 125 VAC. The LED 124 can be a power indicator light and the LED 176 can be a fault indicator light. In this manner, an electrical outlet device is provided that affords for a step-down voltage to be used by an electrically powered system and yet still allows for at least one power outlet electrical socket to be accessed by an additional appliance.

It should be apparent that a transformer has been provided which can be pluggerd into an ordinary wall outlet or the like to supply increased power where necessary but yet provide one or more outlets for standard power. In this way the transformer can be supplied form an ordinary wall outlet or the like without eliminating the outlets connected to standard power and ordinarily provided by the wall outlet.

The invention is not restricted to the illustrative examples described above. The examples are not intended as limitations on the scope of the invention. Methods, apparatus, compositions and the like described herein are exemplary and not intended as limitations on the scope of the invention. Changes therein and other uses will occur to those skilled in the art. The scope of the invention is defined by the scope of the claims.

I claim:

1. An electrical outlet device for providing a step-down voltage to an electrically powered system, said device comprising:
a housing;
a power inlet electrical plug extending from said housing;
at least one power outlet electrical socket at least partially within said housing and connected in parallel to said electrical plug;
a load within said housing and connected in parallel to said at least one power outlet electrical socket, said load providing the step-down voltage; and
a pair of power outlet electrical contacts extending from said load, said pair of power outlet electrical contacts providing the step-down voltage to the electrically powered system.

2. The device of claim 1, wherein said power inlet electrical plug is a three-pronged 120 volt electrical plug.

3. The device of claim 1, wherein said at least one power outlet electrical socket is two three-pronged 120 volt electrical sockets.

4. The device of claim 1, wherein said load is a step-down transformer having a core, a primary coil and a secondary coil, said primary coil connected in parallel to said power inlet electrical plug and said secondary coil connected in parallel to said pair of power outlet electrical contacts.

5. The device of claim 4, wherein step-down transformer has an input of 120 volts of alternating current at 60 cycles per second and has an output of 16 volts of alternating current at 60 cycles per second.

6. The bypass power pack of claim 4, further comprising a thermistor connected in series between said secondary coil of said step-down transformer and said pair of power outlet electrical contacts.

7. The device of claim 1, further comprising a surge protector connected in series with said two three-pronged 120 volt electrical sockets.

8. The device of claim 7, wherein said surge protector is a common mode surge protector.

9. The device of claim 1, further comprising a surge protector connected in series between said power inlet electrical plug and said load.

10. The device of claim 1, further comprising a voltage suppressor connected in parallel with said power inlet electrical socket.

11. The device of claim 1, further comprising a light emitting diode connected in parallel with said power inlet electrical plug.

12. The device of claim 1, further comprising a light emitting diode connected in parallel with said pair of power outlet electrical contacts.

13. An electrical outlet device for providing a step-down voltage to a security alarm system, said device comprising:
a housing;
a power inlet electrical plug extending from said housing;
a plurality of power outlet electrical sockets at least partially within said housing and connected in parallel to said power inlet electrical plug;
a step-down transformer within said housing, said step-down transformer having a core, a primary coil and a secondary coil, said primary coil connected in parallel to said power inlet electrical plug; and
a pair of power outlet electrical contacts extending from said housing, said pair of electrical contacts connected in parallel to said secondary coil of said step-down transformer for providing the step-down voltage to the security alarm system.

14. The device of claim 13, wherein said power inlet electrical plug is a three-pronged 120 volt electrical plug.

15. The device of claim 13, wherein said at least one power outlet electrical outlet is two three-pronged 120 volt electrical sockets.

16. The device of claim 14, wherein step-down transformer has an input of 120 volts of alternating current at 60 cycles per second and has an output of 16 volts of alternating current at 60 cycles per second.

17. An electrical outlet device for connection to a standard 120 VAC electrical socket and providing a step-down voltage to a security alarm system circuit board while also providing a pair of 120 VAC power outlet electrical sockets for use to power appliances, said device comprising:
a housing;
a 120 VAC power inlet electrical plug extending from said housing;
a pair of 120 VAC power outlet electrical sockets at least partially within said housing and connected in parallel to said power inlet electrical plug for providing power to appliances;
a step-down transformer within said housing, said step-down transformer having a core, a primary coil and a secondary coil, said primary coil connected in parallel to said 120 VAC power inlet electrical plug and said secondary coil operable to provide 16 VAC; and
a pair of power outlet electrical contacts extending from said housing, said pair of electrical contacts connected in parallel to said secondary coil of said step-down transformer for providing 16 VAC to the security alarm system circuit board.

18. The device of claim 17, further comprising a surge protector connected in series with said pair of 120 VAC power outlet electrical sockets.

19. The bypass power pack of claim 17, further comprising a thermistor connected in series between said secondary coil of said step-down transformer and said pair of power outlet electrical contacts.
